(19) United States
(12) Patent Application Publication
(10) Pub. No.: US 2025/0053151 A1
(43) Pub. Date: Feb. 13, 2025

(54) INFORMATION PROCESSING DEVICE AND PROGRAM

(71) Applicant: DMG MORI CO., LTD., Nara (JP)

(72) Inventor: Yorihito KODA, Nara (JP)

(73) Assignee: DMG MORI CO., LTD., Nara (JP)

(21) Appl. No.: 18/718,660

(22) PCT Filed: Dec. 16, 2022
(86) PCT No.: PCT/JP2022/046310

§ 371 Date: Jun. 11, 2024

(30) Foreign Application Priority Data
Dec. 22, 2021 (JP) 2021-208246
Feb. 25, 2022 (JP) 2022-028305

(51) Int. Cl. G05B 19/408

(52) U.S. Cl. CPC G05B 19/408

(57) ABSTRACT

An information processing device generates a first NC program used in a machine tool. This information processing device includes: a first conversion unit that converts a second NC program into CL data; an interpretation unit that interprets the CL data; an acceptance unit that accepts input of an executable code executable by the machine tool; and a second conversion unit that converts the CL data into a first NC program containing the executable code accepted by the acceptance unit on the basis of the interpretation of the CL data.

### TECHNICAL FIELD

The present invention relates to an information processing device that generates an NC program used in machine tools.

### BACKGROUND ART

In the above technical field, PTL 1 discloses a technic that modifies a tool path of CL (Cutter Location) data generated by CAM (Computer Aided Manufacturing) and outputs the modified data as a G code by a post-processor.

This CL data can be generated not only in a format standardized by ISO (International Organization for Standardization), but also in a unique format that varies among CAM manufacturers. For this reason, converting CL data into NC programs requires development of a unique post-processor for each CAM, which takes a huge amount of cost and time.

In addition, various machine tools are deployed by each of machine tool manufacturers, so that it is difficult for CAM distributors to develop a post-processor that can convert the CL data into an NC program incorporating various optional functions of each machine tool.

### CITATION LIST

### Patent Literature

### [PTL 1]

JP 2021-039533 A

### SUMMARY OF INVENTION

### Technical Problem

Therefore, even if useful functions are implemented in a machine tool, it is not possible to convert the CL data into an NC program and only a general-purpose function is available.

### Solution to Problem

Therefore, the present invention provides an information processing device that generates a first NC program used in a machine tool, including: a first conversion unit that converts a second NC program into CL data; an interpretation unit that interprets the CL data; an acceptance unit that accepts input of an executable code executable by the machine tool; and a second conversion unit that converts the CL data into a first NC program containing the executable code accepted by the acceptance unit on the basis of the interpretation of the CL data.

The present invention also provides an information processing device, a machine tool, and a program, among others.

### Advantageous Effects of Invention

The present invention makes it possible to generate programs that can implement a performance of a machine tool at a higher level.

### BRIEF DESCRIPTION OF DRAWINGS

FIG. 1 is a block diagram illustrating a configuration of an information processing device according to a first embodiment.

FIG. 2 is a block diagram illustrating a configuration of an information processing device according to a modified example.

FIG. 3 is a block diagram illustrating a configuration of an information processing device according to a second embodiment.

FIG. 4 illustrates a specific example of processing of an NC program.

FIG. 5 illustrates a specific example of processing of an NC program according to Modification 1.

FIG. 6 illustrates a specific example of processing of an NC program according to Modification 2.

FIG. 7 illustrates a specific example of processing of an NC program according to Modification 3.

FIG. 8 illustrates an executable code setting screen according to Modification 4.

FIG. 9 illustrates a specific operation on the executable code setting screen.

FIG. 10 illustrates a specific operation on the executable code setting screen.

FIG. 11 illustrates a specific operation on the executable code setting screen.

FIG. 12A illustrates a specific operation on the executable code setting screen.

FIG. 12B illustrates a specific operation on the executable code setting screen.

FIG. 13 illustrates a specific operation on the executable code setting screen.

FIG. 14 illustrates a specific operation on the executable code setting screen.

### DESCRIPTION OF EMBODIMENTS

Hereafter, an embodiment of the present invention is described in detail by way of example with reference to the drawings. However, the components described in the following examples are illustrative only, and the scope of the invention is not intended to be limited to them.

### First Embodiment

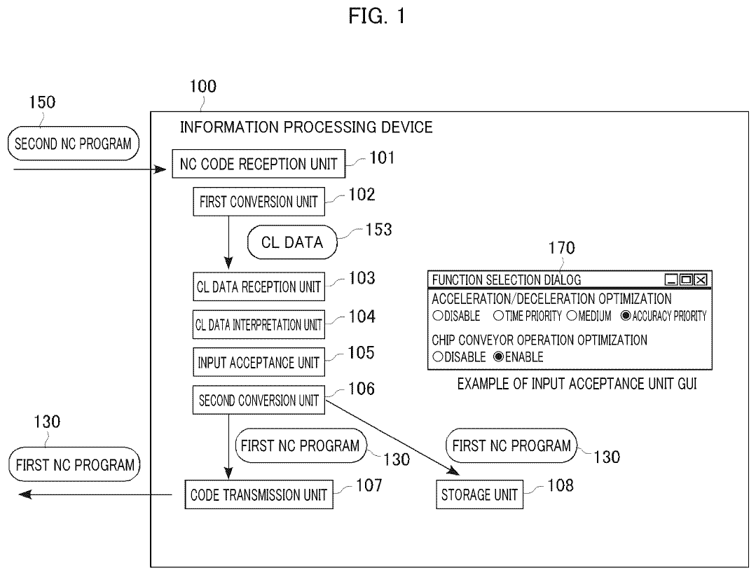

FIG. 1 is a block diagram illustrating a configuration of an information processing device according to a first embodiment.

An information processing device 100 is a device for generating a first NC program 130 as a program used in a machine tool. The information processing device 100 includes an NC code reception unit 101, a first conversion unit 102, a CL data reception unit 103, a CL data interpretation unit 104, an input acceptance unit 105, a second conversion unit 106, a code transmission unit 107, and a storage unit 108. This program is preferably a program used in machine tools used for, e.g., machining (machining program), tool and workpiece transportation (transportation program), measurement, and image capturing.

The NC code reception unit 101 receives a second NC program 150 from the outside. The first conversion unit 102 converts the second NC program 150 into CL data 153. The CL data reception unit 103 acquires the CL data 153, and the CL data interpretation unit 104 interprets the CL data 153.

The input acceptance unit 105 accepts the selection of a code executable by the machine tool (executable code) on the basis of an operation input conducted by a user via a GUI screen 170. For example, as the GUI screen 170, a function selection dialog shown in the figure is displayed. The selection of the accuracy priority (one function) in this function selection dialog as shown in the figure means an acceptance of the input of the executable code corresponding to the accuracy priority (the code that specifies finishing, such as PROCMOD/FIN, G332R3). Here, “PROCMOD/FIN” is an example of an executable code in CL data, and “G332R3” is an example of an executable code in NC codes.

The second conversion unit 106 converts the CL data 153 into the CL data 153 containing the executable code or the NC program containing the executable code on the basis of the interpretation of the CL data 153 by the CL data interpretation unit 104. When converting the CL data 153 into the CL data 153 containing the executable code, the second conversion unit 106 further converts the CL data 153 into the first NC program 130. Of course, the second conversion unit 106 may not convert the CL data 153 into the CL data 153 containing the executable code, but may directly convert the CL data 153 into the first NC program 130 containing the executable code. The storage unit 108 stores this first NC program 130, but may also store other NC programs that are externally input. The code transmission unit 107 transmits the first NC program 130 to a numerical control device of a machine tool. It should be noted that the code transmission unit 107 may not be provided, or for example, the NC program may be output to a storage medium such as a USB memory.

Although this embodiment is described as the information processing device, it is sufficient for an embodiment to include a CL data interpretation means and a conversion means that converts CL data into an NC program containing the executable code on the basis of the input of the executable code executable by the machine tool. Therefore, the present invention can also be implemented as a program or application in addition to the information processing device.

Furthermore, in the present embodiment, the information processing device has been described as having a GUI screen, but the GUI screen may be displayed on a screen of a terminal PC via the Internet, and the information processing device may be provided separately from the terminal PC. The storage unit of the information processing device of this embodiment may be provided in another second information processing device. In the case of the external storage unit, a program acquisition request may be transmitted to the external storage unit, and when the requested program is in the storage unit, the program may be transmitted from the storage unit to the information processing device.

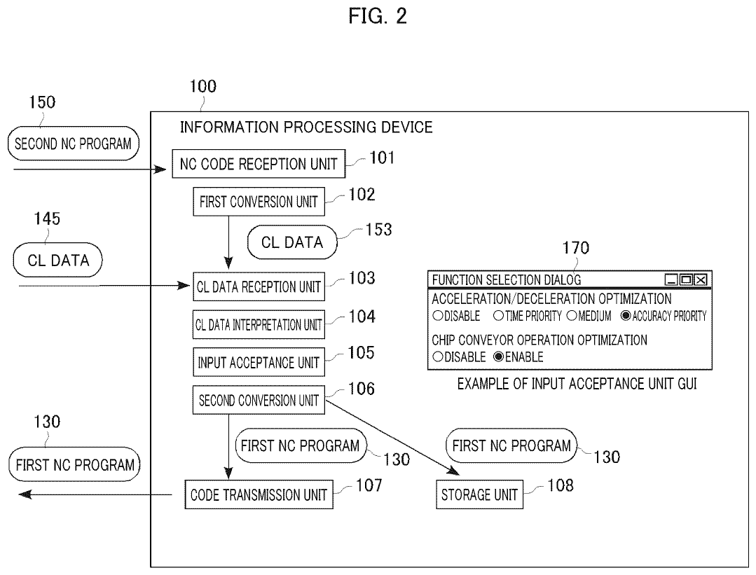

FIG. 2 is a block diagram illustrating a configuration of an information processing device according to a modified example.

In the first embodiment, a configuration is exemplified in which only an NC program (second NC program) is acquired from the outside and the CL data obtained by reversely converting the NC program is interpreted. In this modification, it is also possible to obtain NC programs and CL data from the outside. In other words, the CL data reception unit 103 can externally acquire CL data 145. The CL data interpretation unit 104 interprets not only the CL data 153 converted from the NC program but also CL data 145 transmitted from the outside.

### Second Embodiment

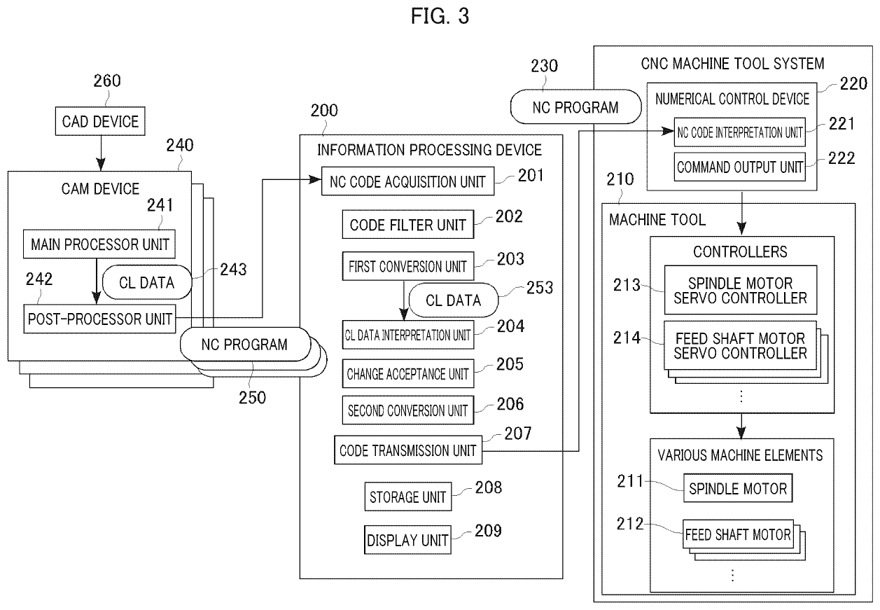

FIG. 3 is a block diagram illustrating a configuration of an information processing device according to a second embodiment.

An information processing device 200 is a device for generating an NC program 230 (first NC program) used in a numerical control device 220. The numerical control device 220 is a device that mainly numerically controls machining in a machine tool 210 and includes an NC code interpretation unit 221 that interprets the NC program 230 and a command output unit 222 that outputs control commands to the machine tool 210.

Examples of the machine tool 210 include machine tools that process workpieces by additive manufacturing, machine tools that process workpieces by subtractive manufacturing, and machine tools that process workpieces by irradiating light such as lasers. Specifically, examples of the machine tool 210 may include a lathe, drilling machine, boring machine, milling machine, tooth cutter, grinder, multi-axis machine, laser machine, and laminating machine, which are numerically controlled according to an NC program and perform various machining such as turning, cutting, drilling, grinding, polishing, rolling, forging, folding, forming, micromachining, and laminating on workpieces such as metal, wood, stone, and resin. Furthermore, the machine tool may have a measuring function or be configured to measure dimensions of workpieces by using a measuring instrument such as a touch probe or camera.

The machine tool 210 is, e.g., a 3-axis machine and includes a spindle motor 211 and a feed shaft motor 212 as machine elements. The spindle motor 211 rotates the tool, and the feed shaft motor 212 moves the table linearly in the X- and Y-axis directions or the tool or table linearly in the Z-axis direction through ball screws or the like. The machine tool 210 may of course be a 5-axis machine.

A spindle motor servo controller 213 controls the spindle motor 211 on the basis of a control command from the command output unit 222. A feed shaft motor servo controller 214 controls the feed shaft motor 212 on the basis of a control command from the command output unit 222.

Each component of the information processing device 200 is implemented by software that supplies processing instructions to CPU (Central Processing Unit) and a computing unit such as various computer processors. Each of the blocks, such as the code filter unit and the CL data interpretation unit described below, represents a functional block.

The information processing device 200 includes an NC code acquisition unit 201, a code filter unit 202, a first conversion unit 203, a CL data interpretation unit 204, a change acceptance unit 205, a second conversion unit 206, a code transmission unit 207, a storage unit 208, and a display unit 209.

The NC code acquisition unit 201 acquires an NC program 250 (second NC program) generated in a CAM device 240. The CAM device 240 has a main processor unit 241 and a post-processor unit 242. The main processor unit 241 generates CL data 243 on the basis of shape data acquired from a CAD (Computer-Aided Design) device 260. The post-processor unit 242 generates the NC program 250 from the CL data 243.

The storage unit 208 stores various program modules. A processor of the information processing device 200 implements the functions of each unit by executing various program modules. The storage unit 208 also stores the correspondence between the NC code and the CL data. The code filter unit 202 performs filtering to delete codes without corresponding CL data (also referred to as non-corresponding codes) from among the NC codes included in the NC program 250. Then, the reverse conversion to CL data by the first conversion unit 203 or the interpretation of CL data by the CL data interpretation unit 204 described later is performed. Although the code filter unit 202 and the first conversion unit 203 are described as having separate functions in this embodiment, the code filter function may be included in the first conversion unit 203. For example, the first conversion unit 203 performs processing for sequentially converting the code of the NC program into CL data. When reaching a non-corresponding code during the processing, the first conversion unit 203 deletes the non-corresponding code. Then, the first conversion unit 203 reaches the code next to the non-corresponding code in the NC program, and if the next code is a corresponding code, performs processing to convert it into CL data. By repeatedly performing the above processing on every reached non-corresponding code in sequence, the first conversion unit 203 can implement the code filter function. Specifically, among the codes in the second NC program, the first conversion unit 203 converts corresponding codes having corresponding CL data. Among the codes in the second NC program, the first conversion unit 203 processes non-corresponding codes having no corresponding CL data in a manner different from processing performed on the corresponding codes.

The correspondence between the NC code and the CL data is stored in the storage unit 208 of the information processing device 200 in this embodiment, but may be stored in an external device instead of the information processing device 200. The correspondence between NC codes and CL data is preferably prepared in advance. For example, the codes such as G00, G01, and G06, the functions of which are specified in ISO 6983-1:2009 or JIS (Japanese Industrial Standards) B 6315-1:2013 can be associated with the corresponding CL data in advance. Also, even for the codes such as G100 to G999 the functions of which are not specified in ISO 6983-1:2009 or JIS B 6315-1:2013, it is possible to specify functions of some G codes executable by the machine tool, create corresponding CL data, and associate NC codes with CL data. For reference, the codes the functions of which are specified in JIS B 6315-1:2013 include G00 to G04, G06, and G09. The codes the functions of which are not specified in JIS B 6315-1:2013 include G100 to G999. In addition, the codes not assigned in JIS B 6315-1:2013 include G1000 to G1100.

In the case of filtering to delete a code as in the present embodiment, a list of NC codes to be deleted may be stored without using data of the correspondence between NC codes and CL data, thereby performing filtering to delete the corresponding codes.

The first conversion unit 203 reversely converts the filtered NC program 250 into CL data 253 described by APT (Automatically Programmed Tools). APT is a programming language developed for numerical control of machine tools, which can automatically specify tool paths and machining procedures on the basis of the shape of machine parts to be manufactured. Alternatively, EXAPT (extended subset of APT), which is a precisely-improved version of the tool path determination function of APT, may be used. Normally, conversion of APT to NC is generally performed in the post-processor, but the first conversion unit 203 performs the reverse conversion of NC to APT.

In addition, when the NC program is converted into CL data, it is preferable to classify and convert the data by a certain source. For example, suppose there is an NC program that instructs machining and measurement. The first conversion unit 203 groups the CL data for machining and the CL data for measurement, and converts them into CL data in such a way that they can be identified. In this way, it is possible to reduce the time required to decide which CL data is to be changed when a change input for changing the measurement point or the number of measurements is received on the GUI screen. Such grouping and process segmentation can also enable processing to present program modification options that can be optimized by the machine tools used according to groups and process information.

The CL data interpretation unit 204 interprets the reversely converted CL data 253, i.e., the CL data described by APT (hereinafter also referred to as “APT data”).

The change acceptance unit 205 accepts input of an executable code executable by the machine tool 210 for the APT data. The executable codes executable by the machine tool 210 may include function codes that implement functions specific to the machine tool 210 or the numerical control device 220, and function codes that implement specific functions such as measurement in machining such as finishing and image capturing. The display unit 209 displays a GUI screen to be described later for accepting the executable code.

The second conversion unit 206 converts the CL data 253 (APT data) into the NC program 230 containing the executable code accepted by the change acceptance unit 205. This NC program can be referred to as an optimized program (a program subjected to optimization processing). The code transmission unit 207 transmits the NC program 230 to the numerical control device 220.

Here, optimization processing is a concept that includes all processing that benefits machining, such as reducing machining time, improving machining accuracy, saving power and coolant, efficiently removing chips, improving efficiency through process control visualization, and measurement processing, among others. Specifically, optimization processing includes, but is not limited to, the following (1) to (4).

### (1) Optimization of Servo Characteristics

When machining modes such as (a) to (d) below are implemented by a custom macro, machining accuracy and machining time can be optimized by selecting the desired machining mode.
(a) Time priority mode: a mode that gives top priority to reducing machining time. This mode is used when required accuracy is low such as roughing.
(b) Middle mode: a mode that is intermediate between the time-first and accuracy priority modes. This mode is used for, e.g., medium finishing which requires high accuracy and short time.
(c) Accuracy priority mode: a mode that gives top priority to the improvement of machining accuracy. This mode is used when machining accuracy and finished surface are required.
(d) Accuracy top-priority mode: a mode that further prioritizes machining accuracy over the accuracy priority mode.

### (2) Automatic Optimization of Servo Characteristics

When a function for automatically adjusting the servo is implemented by a PLC, the mass and moment of inertia of the workpiece or jig are measured and the optimum acceleration/deceleration is set on the basis of the feedback value. Specifically, when the mass of the workpiece or jig is heavy and the moment of inertia is large, the acceleration/deceleration is suppressed to stabilize positioning. In contrast, when the mass of the workpiece or jig is light and the moment of inertia is small, the acceleration/deceleration is maximally increased to reduce the machining time.

(3) Optimization of on/Off Control of Chip Conveyor

When the on/off function of a chip conveyor for discharging chips is implemented by a PLC, the volume of chips over time is calculated by machining simulation, and the on/off control of the chip conveyor is optimized according to the amount of chips. Specifically, during non-cutting or when the amount of chips is small, turning off the chip conveyor will save the driving power of the chip conveyor and improve the use efficiency of cutting oil.

### (4) Optimization of Process Control

When the function of tagging the same machining process with a common machining process ID is implemented among the NC viewers of the HMI of the CAM device, the information processing device, and the machine tool, the following functions can be implemented to optimize the process control.
A function to display or update changes in a subsequent process
A function to highlight changes when operating a machine tool
A function to stop at previous positioning command
A function to update the previous process with the changes, when only numerical values such as feed rate and spindle speed have been changed

The storage unit 208 stores program modules that implement the NC code acquisition unit 201, the first conversion unit 203, the CL data interpretation unit 204, the change acceptance unit 205, the second conversion unit 206, and the code transmission unit 207. In addition, the storage unit 208 stores correspondence information between the above NC code and CL data, command table, machine tool information, and numerical control device information, among others. Here, the command table is a table indicating the correspondence between commands and arguments in the standardized format and NC codes.

Machine tool information is information about various machine tools of different machine tool manufacturers and models, such as machine origin, model stroke length, G code of machine specific instructions, and M code (Mxx, Mxy), and may also include the following information.
(1) Model number of machine tool
(2) Optional Information (number of turrets, spindle diameter, servo, type and presence/absence of chip conveyor, type and presence/absence of measuring device)
(3) Available tool types (e.g., drill and end mill)
(4) Number of pots and pot numbers in the magazine

In addition, the optimization processing may be based on the G code defined in ISO. For example, all CAM devices have common G codes (as defined by ISO) such as G00, G01, G02, and G03. The change acceptance unit 205 can also perform optimization processing to add optimized functions on the basis of such ISO-compliant G codes.

Although the code filter unit 202 of the present embodiment filters and deletes non-corresponding codes, the present invention is not limited to this. The following two options may be presented to the user. It is desirable that the G/M code filters can be edited by an operator.
OPTION 1. Codes are output as they are.
OPTION 2. Codes in the G/M code filter are removed.

The information processing device 200 may further include a setting unit for setting whether to delete non-corresponding codes from the NC program. The code filter unit 202 may perform filtering of the NC program according to the settings set by the setting unit.

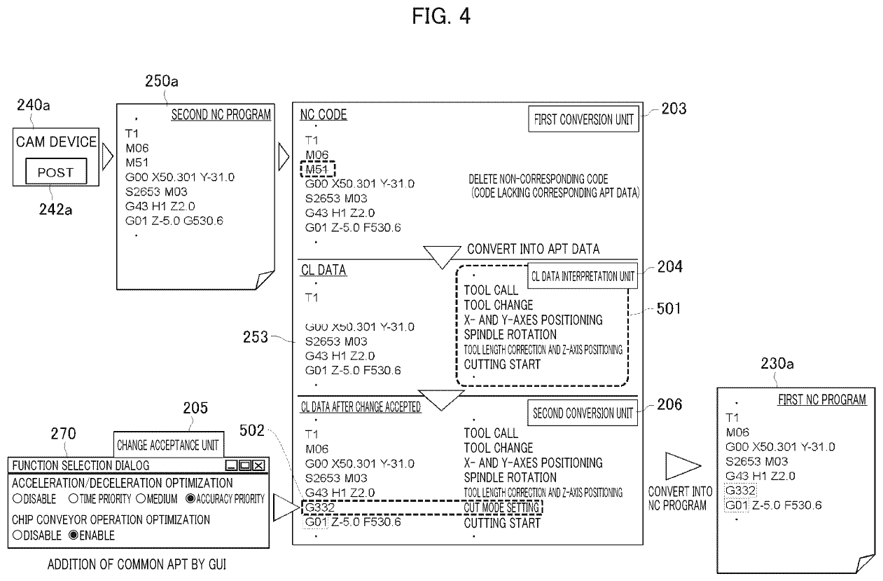

FIG. 4 illustrates a specific example of processing until optimization of an NC program.

In this example, the second NC program 250a is output from the post-processor unit 242a of the CAM device 240a. The first conversion unit 203 has a code filter means corresponding to the code filter unit, and deletes non-corresponding codes (codes lacking corresponding APT data) from the second NC program 250a. FIG. 4 illustrates an example in which M51 is deleted before CL data conversion because M51 is a non-corresponding code. G codes and M codes that are non-corresponding codes are stored in advance in the code list.

The first conversion unit 203 further reversely converts the filtered NC program 250a into CL data 253 (APT data). The CL data interpretation unit 204 adds an interpretation result 501 to the CL data 253. Note that the example in FIG. 4 is only conceptually illustrated and does not mean that data is added as a Japanese text in this way. The CL data interpretation unit 204 interprets the CL data; however, the figure still shows NC codes so that the processing flow is easy to understand.

The change acceptance unit 205 displays a GUI screen 270 for allowing the user to select whether or not to insert a cutting mode setting code 502 of G332 immediately before the cutting start code G01 for optimization. The GUI screen 270 can be displayed, e.g., as a function selection dialog as shown in the figure, and can accept the selection of code executable by the machine tool. The selection of the accuracy priority in the function selection dialog shown in the figure means an acceptance of the input of G332R3 (described later).

The change acceptance unit 205 accepts a selection by a user via the GUI screen 270. Thus, machining is optimized before the start of cutting. Here, the codes G01 and G332 may be the NC program codes itself or the CL data codes corresponding to the NC program codes.

For example, G332 is the NC code for selecting the machining mode (cutting mode) of (a) to (d) described above. Specifically, any one of “G332R1”, “G332R2”, “G332R3”, or “G332R4” is inserted just before the cutting start code G01 in the NC program. The arguments R1 to R4 are set in the following cases.
R1: set for roughing (time priority mode)
R2: set for medium finishing (middle mode)
R3: set for finishing (accuracy priority mode)
R4: manually set by a user only when desired (accuracy top-priority mode)

For example, when OPTYPE/ROUGH (roughing) is set as an executable code in the APT data, the G code and argument of G332R1 is inserted. Alternatively, when OPTYPE/FINISH (finishing) is set as an executable code in the APT data, the G code and argument of G332R3 is inserted.

In this example, when the code of the NC program is G332R1, the CL data code corresponding to the NC program code will be OPTYPE/ROUGH (roughing). Similarly, when the code of the NC program is G332R3, the code of the CL data corresponding to the code of the NC program is OPTYPE/FINISH (finishing).

As mentioned above, G332 is a code unspecified in JIS. This allows machine tool and numerical control device vendors to specify functions for individual applications. Therefore, functions specific to individual machine tools and functions specific to individual numerical control devices can be defined. In this case, the NC program containing the executable code of this G332 can be generated to implement the optimization conformed to the machine tool to be used.

The information processing device 200 performs processing to delete or ignore (comment out) the preset setting function code among the function codes the function of which is not specified in ISO 6983-1:2009 or JIS B 6315-1:2013 from the program before processing. Then, the information processing device 200 detects an origin code (origin data) from the multiple codes contained in the program before processing and presents the code corresponding to the origin code to the user as an executable code (additional code). When the user makes a selection via the GUI screen 270, the change acceptance unit 205 performs processing to add an executable code corresponding to the origin code.

The second conversion unit 206 converts the CL data after processing (processed CL data), which is the CL data after the executable code is added to the CL data 253 before processing (unprocessed CL data) before the executable code is added, into the NC program 230.

For reference, the codes the functions of which are specified in JIS B 6315-1:2013 include G00 to G04, G06, G09, M00 to M06, and M10. In addition, M07 to M09 are specified in other ISO or the like, although no functions are defined in JIS B 6315-1:2013. For example, M07 is noted by “see, ISO/TR 6983-2”.

The examples of the codes the functions of which are not specified in JIS B 6315-1:2013 include G05, G07, G50 to G52, and G100 to G999. These G codes are numbered in JIS B 6315-1:2013, but the functions of them are described as unspecified. In addition, examples of the codes the functions of which are not specified in JIS B 6315-1:2013 include codes not described in JIS B 6315-1:2013, such as M51 and M59.

### Modifications

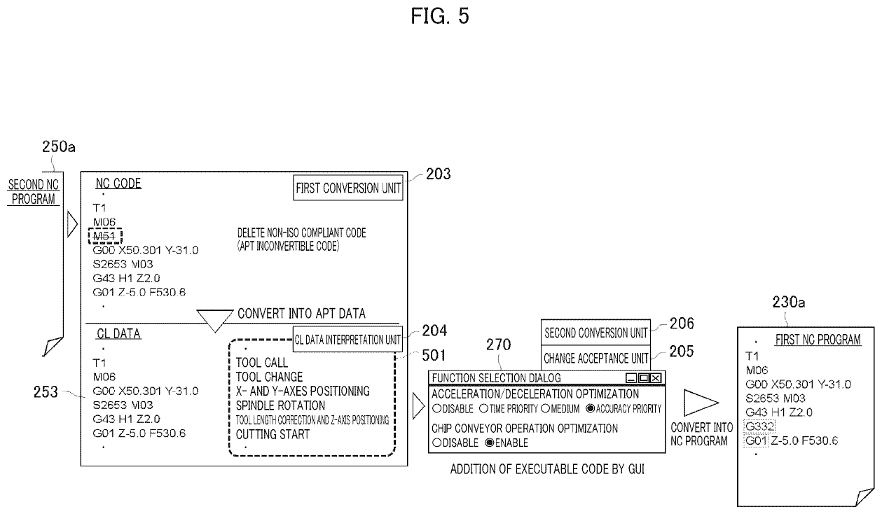

FIG. 5 shows a specific example of processing of an NC program according to Modification 1.

In this modification, the NC program 250a (second NC program) is reversely converted by a conversion means, which is the first conversion unit 203. The converted CL data 253 (APT data) is interpreted by an interpretation means, which is the CL data interpretation unit 204. The CL data interpretation unit 204 also detects processes, correspondence between codes and processes, meaning of each code, and origin codes. The conversion means, which is the second conversion unit 206, generates the NC program by adding a code corresponding to the selection input by the user on the GUI screen to a position related to the origin code detected by the CL data interpretation unit 204.

This modification does not generate the CL data to which the code of the CL data corresponding to the input accepted by the change acceptance unit 205 is added, but directly converts unprocessed CL data into the NC program. In other words, the second conversion unit 206 generates the NC program on the basis of the CL data 253 before processing (unprocessed CL data) before the executable code is added and the input accepted by the change acceptance unit 205.

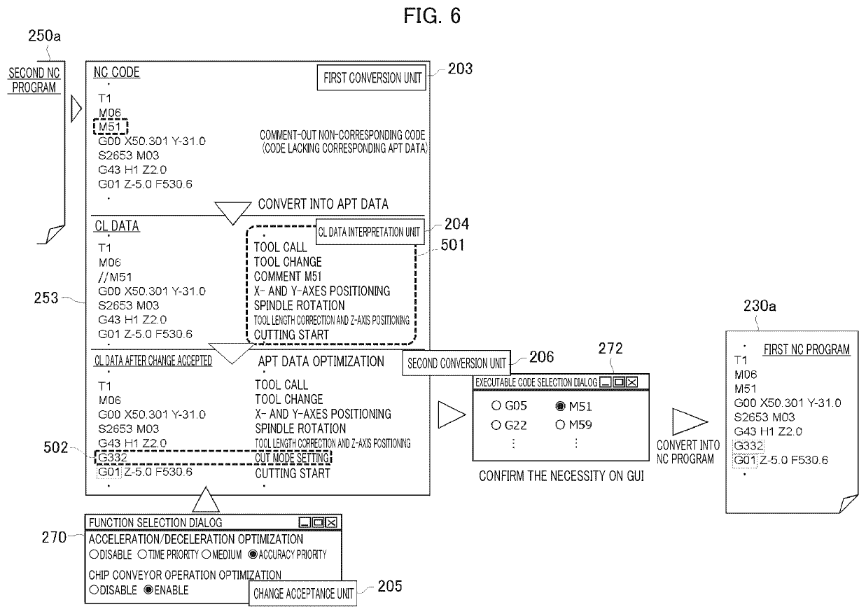

FIG. 6 illustrates a specific example of processing of an NC program according to Modification 2.

In the second embodiment, an example is shown in which non-corresponding codes (codes lacking corresponding APT data) are deleted from the NC program 250a (the second NC program) and is not incorporated into the NC program 230a (the first NC program).

In this modification, when a non-corresponding code is detected in the NC program 250a, this detected non-corresponding code is temporarily ignored (commented out). FIG. 6 shows an example in which M51 is commented out by adding “//” before M51 in the first conversion unit 203 since M51 is a non-corresponding code. As in the second embodiment, the change acceptance unit 205 accepts a selection by a user via the GUI screen 270. Furthermore, when converting the CL data 253 after the change processing into the NC program 230a, the display unit 209 displays a GUI screen 272. In FIG. 6, the GUI screen 272 is an executable code selection dialog, which shows the codes commented out in the first conversion process. In the executable code selection dialog shown in FIG. 6, codes M51, M59, G05, and G22 are presented, all of which are commented out and ignored as non-corresponding codes in this example. The user can restore the code which was ignored (ignored code) via this GUI screen 272.

If an ignored code is selected by the user, the second conversion unit 206 incorporates the ignored code (M51 in the illustrated example) as the NC code (executable code) when converting the CL data 253 into the NC program 230a, thereby generating the NC program. On the other hand, G05, G22, and M59 were not selected so that the second conversion unit did not generate the NC program containing G05, G22, and M 59 because there was no input to restore them. Specifically, the change acceptance unit 205 may accept the selection input by the user for processing of a non-corresponding code. The second conversion unit 206 converts CL data into the first NC program on the basis of the selection input by the user.

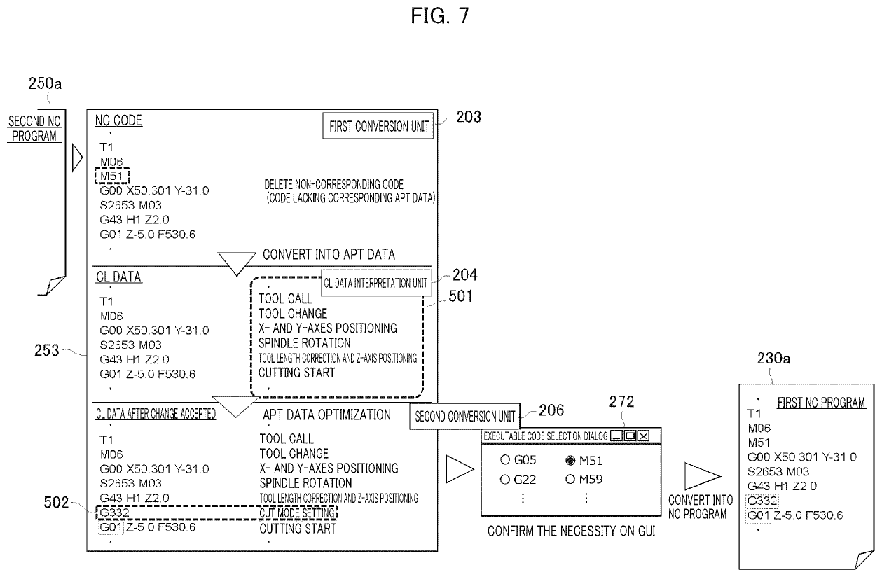

FIG. 7 illustrates a specific example of processing of an NC program according to Modification 3.

In this modification, the GUI screen 270, which is part of the change acceptance unit 205 in Modification 2, is not displayed. The CL data interpretation unit 204 interprets the CL data 253 (APT data) to detect the origin code G01. The second conversion unit 206 generates an NC program into which an executable code G332 corresponding to the origin code G01 is inserted. The second conversion unit 206 shown in FIG. 7 first generates processed CL data into which CL data corresponding to the executable code G332 (corresponding CL data) is inserted. Then, the second conversion unit 206 performs conversion processing on the basis of the processed CL data into which the corresponding CL data has been inserted, and further inserts the NC code selected in the executable code selection dialog (M51 in the example shown) to generate the first NC program 230a.

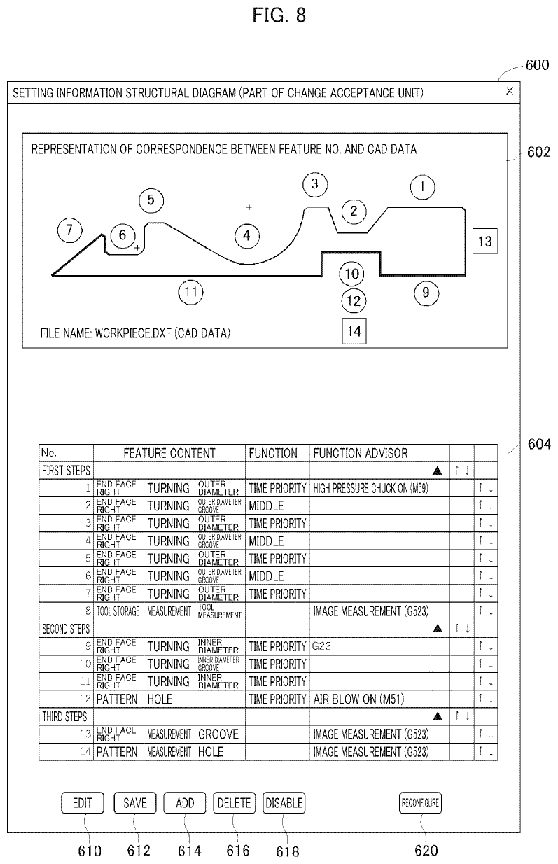

FIG. 8 illustrates an executable code setting screen according to Modification 4.

In this modification, the change acceptance unit 205 accepts an operation input conducted by a user via an executable code setting screen 600. Thus, the machining program (NC program) is optimized before the start of cutting. The executable code setting screen 600 includes a workpiece display screen 602 at an upper portion and a process setting screen 604 at a lower portion.

On the workpiece display screen 602, a shape of the workpiece based on the CAD data is displayed, and feature numbers are superimposed on the screen along the shape. Here, “feature” refers to a processing step, such as machining or measurement, and includes the geometric features that characterize the machining step. The feature numbers corresponding to machining steps are enclosed by a round flame and the feature numbers corresponding to measurement steps are enclosed by a square frame so that they can be identified from each other.

On the process setting screen 604, the results of analyzing the NC program or CL data are presented individually for each feature, and each column of feature number (No.), feature content, function, function advisor, etc., is provided. Items presented in each column can be optionally selected by operation input conducted by a user such as taps and mouse clicks on the screen.

Each feature number corresponds to the number of the processing step. The “feature content” column shows the type of processing, such as machining or measurement, and its details. The “function” column indicates settings related to optimization processing. The “function advisor” column shows the code filtered by the filtering function. If the filtered code is a code that can be used in the present machine tool, a description of the function and the filtered code are displayed as input assistance.

In the example of FIG. 8, features 1 to 8 are set as the first steps, features 9 to 12 are set as the second steps, and features 13 and 14 are set as the third steps. Feature 1 is a step of turning the workpiece from the right of the end face to machine it to a set outer diameter (feature content), and “time priority” is set as an optimization processing (function). For feature 1, M59 is shown as the filtered code and “high pressure chuck ON” is shown as the description of its function. M59 is a code that can be used in the present machine tool, but is filtered in the shown state.

Feature 8 is a step of performing tool measurement upon tool storage (feature content). For feature 8, G523 is shown as the filtered code and “image measurement” is shown as the description of its function. G523 is also a code that can be used in the present machine tool, but is filtered in the shown state.

Feature 9 is a step of turning the workpiece from the right of the end face to machine it to a set inner diameter (feature content), and “time priority” is set as an optimization processing (function). For feature 9, G22 is shown as the filtered code. Since G22 is a code that is not compatible with the present machine tool, there is no description of its function.

The “function” column shows either time priority, middle, or accuracy priority. “Time priority” corresponds to the time priority mode described above, “middle” corresponds to the middle mode, and “accuracy priority” corresponds to the accuracy priority mode. In addition, an option of “accuracy top priority” corresponding to the accuracy top priority mode may be further provided.

On the bottom portion of the process setting screen 604, an edit button 610, a save button 612, an add button 614, a delete button 616, a disable button 618, and a reconfigure button 620 are provided. When a setting item corresponding to a feature as a unit is selected by an operation input conducted by a user, the setting can be modified by tapping these buttons (see below for details).

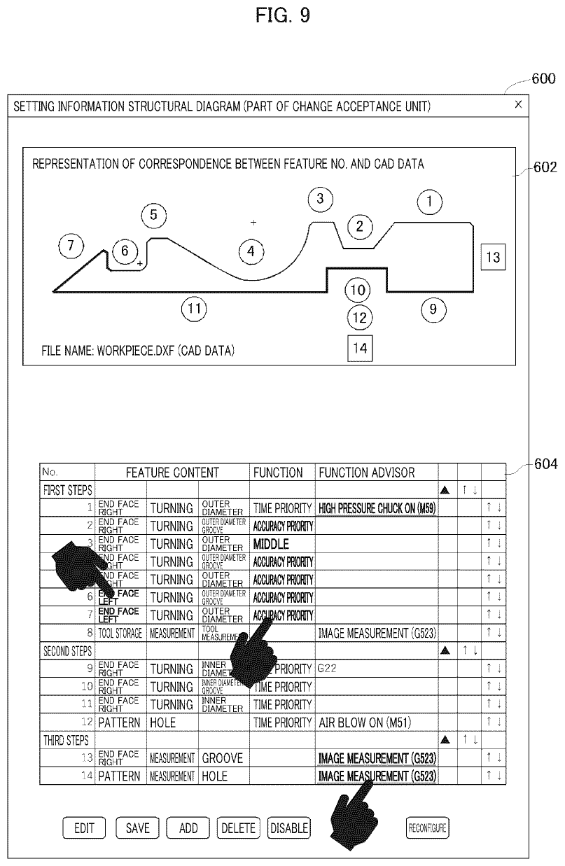

FIGS. 9 to 14 illustrate specific operations on the executable code setting screen.

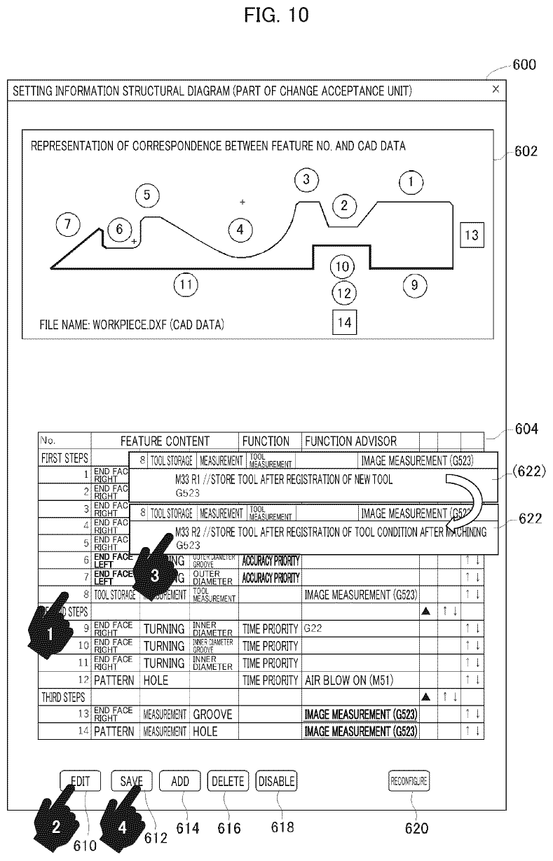

It should be noted that the marks imitating a human hand (pointing marks) in each figure are images representing the selection of items by a user and do not actually appear on the screen. The numbers labeled on the pointing marks (e.g., FIG. 10) indicate the order of selection by the user. When a user conducts the operation input, a cursor may be displayed at the position of the pointing mark.

As shown in FIG. 9, there are three columns for “feature content”: left column, center column, and right column. The left column shows a summary (outline) of the process, the middle column shows the process to be executed, and the right column shows the specific content of the process.

In the left column, “end face right” means to cut the workpiece from the right of the end face, and “end face left” means to cut the workpiece from the left of the end face. When the user touches “end face right”, the cell is changed to “end face left”. In that case, the features the machining positions of which are to the left of the changed feature are automatically changed to “end face left”. In the example of FIG. 9, feature 6 is changed to “end face left” by the touch of the user so that feature 7 is automatically changed to “end face left”. When the user touches “end face left”, the cell is changed to “end face right”. In that case, the features at the machining positions to the right of the machining position of the changed feature are automatically changed so as to be cut from the right of the end face.

The center column shows the type of processing, such as machining or measurement, and the type of machining, such as turning or drilling, for machining. The right column shows the portion to be machined, such as “outer diameter” and “inner diameter”, and the shape to be machined, such as “outer diameter groove” and “inner diameter groove” regarding machining process. Alternatively, the right column shows a measurement object such as “groove” and “hole” regarding measurement processing. For example, feature 12 is a step of drilling a specific pattern. Feature 13 is a step of measuring a groove formed on the right of the end face. Feature 14 is a step of measuring a hole machined in a specific pattern.

Touching an item in the “function” column will sequentially change the content of the optimization processing. That is, touching “time priority” changes the content to “middle” and touching “middle” changes the content to “accuracy priority”. Touching “accuracy priority” changes the content to “time priority”. These indications make it easier for users to understand how they are changing the optimization processing for which features. Upon saving, these settings are reflected in the NC program. More precisely, the internal CL data is changed.

In the “function advisor” column, touching a displayed item will restore disabled or ignored functions. In the example shown in FIG. 9, “high pressure chuck ON (M59)” in feature 1 and “image measurement (G523)” in features 13 and 14 were once filtered out, but the features were restored by the touching operation conducted by the user (emphasized by underline and bold).

Individual features can also be edited directly, as shown in FIG. 10. For example, when the user selects feature 8 and taps the edit button 610, a pop-up window 622 corresponding to that feature will appear, showing the specific NC code, CL data, etc. In the example of FIG. 10, the NC code and its comment are displayed. The user can edit that code directly. The upper pop-up window (622) in the figure shows the code before editing, and the lower pop-up window 622 shows the code after editing. After editing, the user can save the edited state by tapping the save button 612. The setting of the NC program then becomes the edited setting.

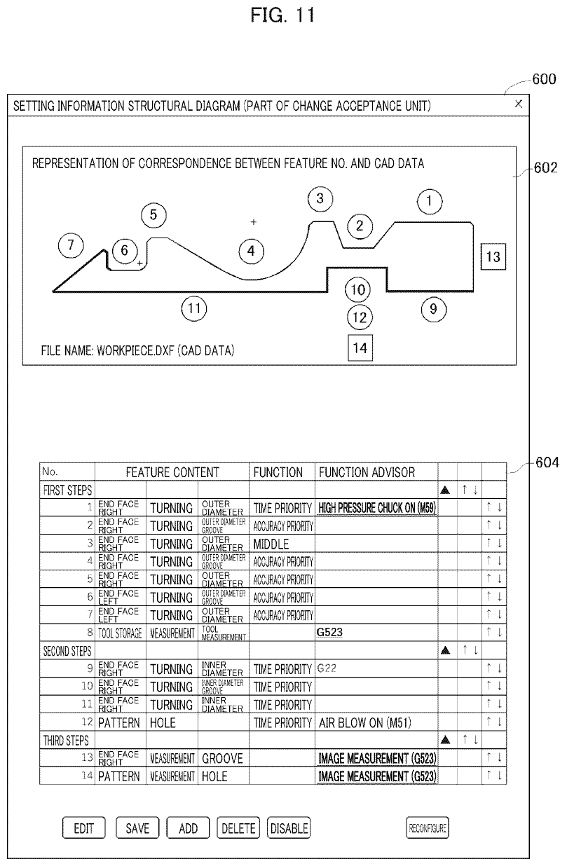

In feature 8 shown in FIG. 10, the filtered item of G523 is shown in the column of “function advisor”. When the user selects this item, G523 is highlighted as shown in FIG. 11, indicating that the code has been restored. In the example of FIG. 11, this highlighting is shown in underlined bold, but it may be shown in highlighter or other manner. In the example of FIG. 10, the code was edited in feature 8 and changed from “M33 R1” to “M33 R2”, so the description “screen measurement” in G523 was erased in the example of FIG. 11. Note that the G22 is not compatible with the present machine tool, but it can be restored by code editing.

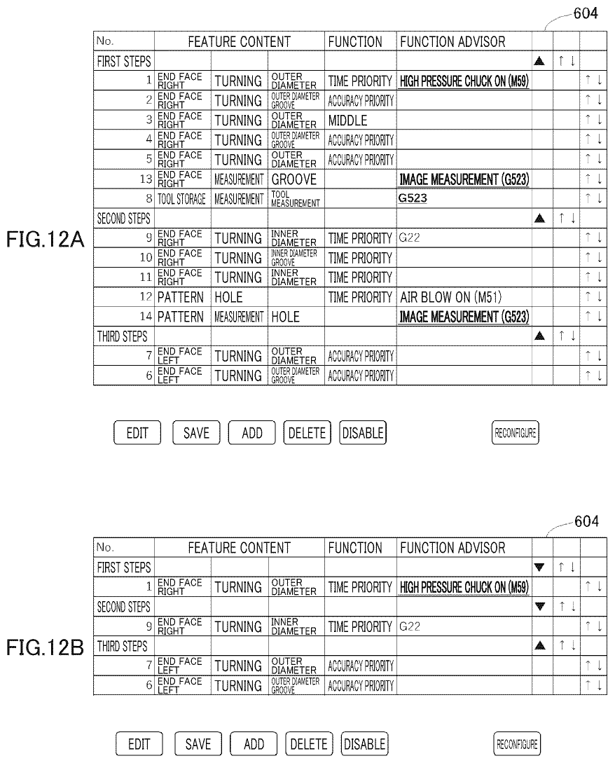

As shown in FIG. 12A, the unit of a feature (i.e., step) can also be moved up and down in the process setting screen 604. This movement can be done by tapping the arrow button on the right end of feature. In the example shown, feature 7 and feature 6 are moved down and feature 13 is moved up. In other words, features can be reordered.

It is also possible to collectively move multiple features such as the first steps or second steps. This collective movement can be done by tapping the arrow button at the right end of the first steps. It should be noted that in the example in FIG. 12A, the order of feature 7 and feature 6 is switched in comparison with the screen in FIG. 10. This is because turning will be started from the end face located on the left side as a result of switching features 6 and 7 to “end face left”.

As shown in FIG. 12B, parts of the entire process can be folded and hidden. In the illustrated example, the first and second steps are folded in the process setting screen 604, and features 2 to 8 of the first step and features 10 to 14 of the second step are hidden. This folding process can be performed by tapping a triangular button (also called a “folding button”) on the right side of each step. When the folding process is done, the notation of the folding button is changed by reversing the orientation of the triangle.

It should be noted that the first features, such as feature 1 in the first steps and feature 9 in the second steps are not hidden. This is because, in the case of machining, it is easy to predict what kind of machining will be included in the steps if it is known what kind of machining is to be started. The folded steps can also be expanded and redisplayed by tapping the fold button again.

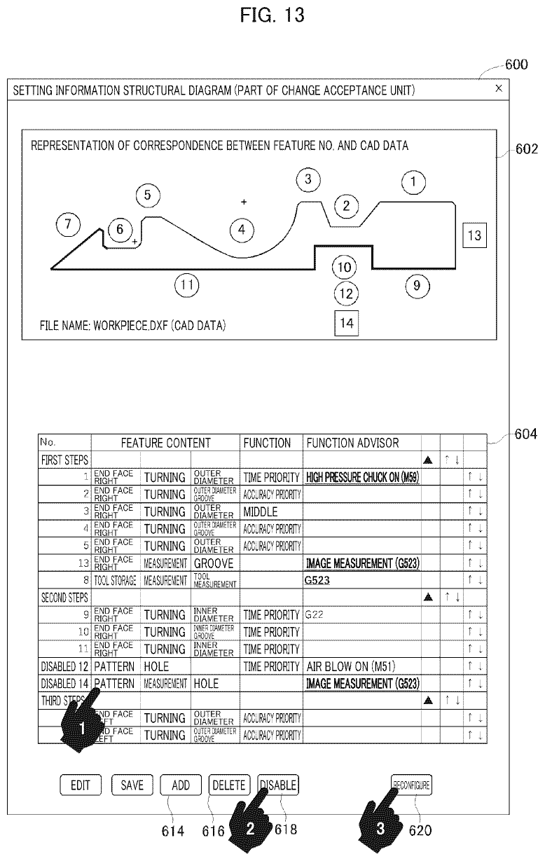

Unused feature units can also be disabled, as shown in FIG. 13. In the illustrated example, by selecting feature 12 and feature 14 and tapping the disable button 618, these steps are disabled. If the reconfigure button 620 is tapped after disabling, the disabled step is deleted and the NC program is reconfigured with the optimized feature configuration. Further, new features can be added by tapping the add button 614. A feature can be deleted by selecting the feature and tapping the delete button 616.

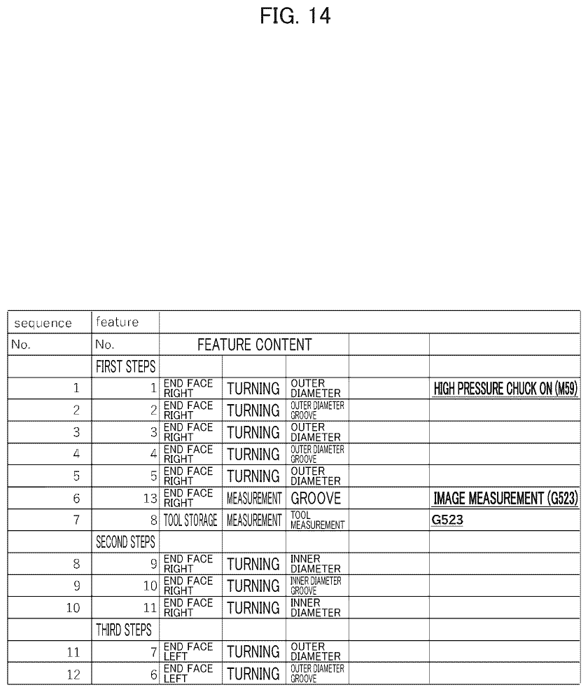

As shown in FIG. 14, the change acceptance unit 205 constructs a new program feature configuration on the basis of the above editing. Each feature is renumbered by a sequence number, which is the sequence of the process after editing. A second conversion unit 206 converts them into an NC program on the basis of that information.

In this modification, after the first conversion unit 203 converts the NC program 250 into CL data 253 (unprocessed CL data), the CL data interpretation unit 204 interprets the CL data 253 and decomposes it for each feature. The change acceptance unit 205 displays the process setting screen 604 (executable code setting screen 600) and edits the feature according to operation input conducted by a user. The second conversion unit 206 converts the CL data (processed CL data) containing the executable codes based on the editing result of the features into the NC program 230.

In other modifications, the executable code may be edited by interpreting the NC program instead of the CL data. That is, the program interpretation unit may interpret the NC program 250 (unprocessed NC program) and decompose the NC program 250 for each feature. The change acceptance unit displays the process setting screen 604 and edits the feature according to operation input conducted by a user. A program conversion unit generates the NC program 230 (processed NC program) so that the NC program 230 includes the executable codes based on the editing result of the features.

The present invention is not limited to the embodiments described above and modifications thereof, and any component thereof can be modified and embodied without departing from the scope of the invention. Components described in the embodiments and modifications can be combined as appropriate to form various embodiments. Some components may be omitted from the components presented in the embodiments and modifications. In addition, the present invention can be implemented as a system, device, method, program, and storage medium, among others. Specifically, the present invention may be applied to a system consisting of multiple devices (e.g., host computers, interface devices, web applications) or to a device consisting of a single device.

A recording medium recording the program code of the software implementing the functions described above may be supplied to the system or device, and the computer of the system or device (CPU, MPU) may read and execute the program code stored in the recording medium. In this case, the program code read from the storage medium itself implements the function of the above embodiment, and the storage medium storing the program code constitutes the above device.

Moreover, not only the above functions are implemented by executing the program code read by the computer, but also the above functions may be implemented by an OS (Operating System) running on a computer performing some or all of the actual processing on the basis of the instructions of the program code.

Furthermore, the program code read from the storage medium may be written to a memory provided on the function extension board inserted into the computer or the function extension unit connected to the computer. Then, in accordance with the instructions in the program code, the CPU provided in the function extension board or function extension unit may perform some or all of the actual processing to implement the above functions.

A program implementing one or more functions of the above embodiment may be supplied to a system or device via a network or storage medium so that one or more processors in the computer of the system or device read and execute the program. A circuit (e.g., ASIC) that implements one or more functions may be provided.

This application claims priority from Japanese Patent Application Nos. 2021-208246 and 2022-028305 filed on Dec. 22, 2021 and Feb. 25, 2022, respectively, the entire contents of which are hereby incorporated by reference herein.

1. An information processing device that generates a first NC program to be used in a machine tool, the information processing device comprising:
a first conversion unit that converts a second NC program into CL data;
an interpretation unit that interprets the CL data;
an acceptance unit that accepts input of an executable code executable by the machine tool; and
a second conversion unit that converts the CL data into a first NC program containing the executable code accepted by the acceptance unit on the basis of the interpretation of the CL data.

2. A program for generating a first NC program to be used in a machine tool, the program comprising:
a first conversion means that converts a second NC program into CL data;
an interpretive means that interprets the CL data;
an acceptance means for accepting input of an executable code executable by the machine tool; and
a second conversion means that converts the CL data into a first NC program containing the accepted executable code on the basis of the interpretation of the CL data.
